(19) United States
(12) Patent Application Publication
(10) Pub. No.: US 2026/0290346 A1
(43) Pub. Date: Sep. 24, 2026

(54) MULTI-MODAL SENSOR ARRANGEMENT FOR NEAR-BODY APPLICATION

(71) Applicant: ALTAVO GMBH, Dresden (DE)

(72) Inventors: Martin LAABS, Dresden (DE); Dirk PLETTEMEIER, Dresden (DE)

(21) Appl. No.: 18/874,225

(22) PCT Filed: Jun. 14, 2023
(86) PCT No.: PCT/EP2023/065984

§ 371 Date: Dec. 12, 2024

(30) Foreign Application Priority Data
Jun. 15, 2022 (DE) 10 2022 115 034.8

(51) Int. Cl. G10L 15/24; G01S 7/02; G01S 7/41; G01S 13/86; G01S 13/88

(52) U.S. Cl. CPC G10L 15/24; G01S 7/027; G01S 7/417; G01S 13/86; G01S 13/88

(57) ABSTRACT

A sensor arrangement for a near-body application comprises a carrier structure one or more conductor structures which are attached to the carrier structure and which are configured to emit or detect electromagnetic waves of a radar measurement. Furthermore, the sensor arrangement comprises at least one sensor which is attached to the carrier structure and which is designed to detect at least one measured variable. In this way, for example, the person's vocal tract can be characterized, e.g., to determine an intended speech utterance.

### TECHNICAL FIELD

Various examples relate to a sensor arrangement that combines an antenna for a radar measurement with a further sensor, for example, an acceleration sensor or strain sensor. Corresponding sensor arrangements can be used to capture sensor data based on which, for example, a vocal tract can be characterized for the purpose of determining an intended speech utterance.

### BACKGROUND

The vocal tract can be characterized in order to determine an intended speech utterance of the person. See, for example, Wagner, Christoph, et al. “Silent Speech Command Word Recognition Using Stepped Frequency Continuous Wave Radar” (2021).

Technical descriptions of the human voice often use the so-called source-filter model. The lungs, trachea, and larynx together form the source. The air is compressed in the lungs and flows up through the trachea to the larynx. In the larynx, the vocal folds—colloquially known as “vocal cords”—form the glottis. The larynx muscles keep the vocal folds under tension by exerting force through the arytenoid cartilages. When speaking with a voice, the pressure in the trachea and the tension of the vocal folds cause them to open and close periodically, thus creating an acoustic vibration, a sound wave. This sound wave is acoustically filtered by the time-varying shape of the vocal tract, consisting of the throat, which consists of the pharynx, oral cavity and nasal cavity, before it exits the mouth and nostrils.

The production of speech from corresponding speech utterances consists of the process of phonation, technically speaking the excitation of an acoustic vibration by the vocal folds, and articulation, i.e., the filtering of the sound spectrum by the temporally varying shape of the vocal tract. The vocal tract is formed by the soft palate, which opens or closes the nasal cavity, of the tongue, of the upper and lower rows of teeth, and of the upper and lower lips.

To characterize the vocal tract, the change in electromagnetic waves of a radar measurement through reflection or transmission at a person's vocal tract is used.

Then, the radar signals can be processed, for example by using an artificial neural network, to determine an intended speech utterance.

### BRIEF SUMMARY

There is a need for sensor arrangements and measurement techniques for characterizing the vocal tract, in particular, to make the determination of an intended speech utterance possible.

This task is solved by the features of the independent claims. The features of the dependent patent claims define embodiments.

Various examples are based on the finding that a precise determination of an intended speech utterance can often benefit from the use of several different measurement methods for measuring a person's vocal tract, in particular vocal tract movements.

A sensor arrangement for a near-body application comprises a carrier structure and one or more conductor structures. The one or more conductor structures are attached to the carrier structure. The one or more conductor structures are configured to emit and/or detect electromagnetic waves of a radar measurement.

In addition, the sensor arrangement comprises at least one sensor which is attached to the carrier structure, wherein the at least one sensor is designed to detect at least one measured variable. Examples would be extension and acceleration. Conductivity could also be measured.

Thus, the sensor arrangement can provide an integration of an antenna formed by the one or more conductor structures (as a “radar sensor”) and the at least one further sensor on the common carrier structure. By integrating said elements in a common sensor arrangement it can be achieved that measurement signals of the different measurement methods are in an aforementioned relationship with each other. The sensor and the radar sensor can relate to different measurement modalities. The sensor and the radar sensor can measure different physical observables.

Various techniques disclosed herein make it possible to determine a characterization of the vocal tract or, for example, in particular an intended speech utterance based on multiple input data for a processing algorithm. In other words, it is possible to use a sensor fusion of several different sensors.

In particular, techniques are described in which a radar measurement is combined with one or more other measurement methods, such as the measurement of acceleration in the area of the vocal tract and/or a deformation or tension of the skin surface in the area of the vocal tract.

A radar measurement can, for example, include the determination of the impulse response of the channel. A radar measurement can thus include an interaction of electromagnetic waves with the tissue and the acquisition of information about this interaction.

There are different ways to implement the carrier structure of the antenna arrangement.

For example, it is conceivable that the carrier structure is extended in two dimensions. The carrier structure can be designed as a thin layer. The carrier structure can be designed to be elastic. Thus, the sensor arrangement could be configured to be applied with its underside onto the person's skin surface.

In a further example, it is conceivable that the carrier structure and the antenna are designed as foils. A polyimide foil could be used. In this way, the carrier structure and the antenna can be implemented as thin elastic foil-based layers. The antenna foil and the carrier structure foil can be glued together. The carrier and antenna foils can also be the same foil (i.e., combined).

For example, it is conceivable that the carrier structure is designed as a textile layer. This means that the carrier structure can consist of or include a woven material. In such an example, the one or more conductor structures of the antenna could be incorporated into the textile layer as threads or ribbons, for example.

In particular, if the carrier structure is implemented as a two-dimensionally extended layer, the sensor arrangement can be designed to be worn directly on the skin surface. For example, it is conceivable that the sensor arrangement additionally comprises an adhesive layer which extends along the carrier structure and has a recess. The sensor arrangement can be stuck to the skin using the adhesive layer.

Then, the at least one sensor could be arranged within the recess. In this case, a sensitive surface of the at least one sensor could be in direct contact to the skin surface. In particular, contact-based measurement methods, for example measurements of stretching/tension of the skin surface or the moisture of the skin surface, are made possible by this design.

For example, it is conceivable that the processing algorithm is implemented by an artificial neural network. This artificial neural network could process, for example in different channels, input data obtained from the radar measurement and further input data obtained on the basis of sensor data from the at least one sensor. This means that sensor fusion can be implemented by the artificial neural network.

In such an example, it is particularly helpful, if the antenna for the radar measurement and the at least one sensor are combined in a specific arrangement relative to each other and relative to the person or skin surface. Then, it is possible to provide the same measurement conditions with respect to such a relative arrangement during the training of the artificial neural network as the ones existing during the measurement itself. By integrating the antenna and the at least one sensor in the common sensor arrangement, such reproducible measurement conditions can be ensured. This fact can increase the accuracy when determining intended speech utterances.

It is also conceivable that the at least one sensor is used to check the correct position of the sensor arrangement on the person's skin. It is conceivable, for example, to measure the conductivity and thus to check whether the one or more conductor structures rest on the skin surface or extend along the skin surface.

Some examples of the at least one sensor are described in the following:

For example, a strain gauge could be used to measure the stretching of the skin surface.

A microelectromechanical sensor with a vibrating mass could be used to detect the acceleration.

An ultrasonic sensor could be used to measure the movement of the person's vocal tract.

An electromyography sensor could be used to determine the electrical muscle activity of a muscle-such as the tongue-in the vocal tract.

It is conceivable to measure the conductivity of the skin surface. A conductivity sensor could be used that measures the resistance between the sensors, which are attached to the cheeks or additionally under the chin, for example, before and during speaking. This solution makes it possible to obtain information about the fit and position of the antennas and their corresponding changes during speaking, about skin resistance (sweat), etc.

Additionally, the sensor arrangement may comprise a communication interface that is configured to multiplex or demultiplex first signals and second signals. The communication interface may be implemented in hardware and optionally in software.

The first signals and the second signals can be transmitted over a common cable by means of the communication interface. The first signals may be associated with the one or more conductor structures, whereas the second signals are associated with the at least one sensor. For example, the first signals could be received by a high frequency (RF) front end and coupled into the one or more conductor structures; in this way, electromagnetic waves can be emitted. The first signals could be RF currents that implement radar chirps. Currents caused by detected electromagnetic waves in the one or more conductor structures can also be led via the cable in the form of the first signals to an RF receiver circuit, which for example comprises a signal amplifier and an analog-to-digital converter.

Accordingly, the second signals can, for example, comprise a supply voltage for the at least one sensor. The second signals could comprise sensor signals of the at least one sensor. Depending on the implementation of the at least one sensor, it is conceivable that the first signals and the second signals have inherently different frequencies, and thus multiplexing includes a simple combination of the first and second signals. For example, a supply voltage for the at least one sensor could be separated from RF currents for the one or more conductor structures by means of low-pass filtering.

However, more complicated multiplexing methods are principally also conceivable, for example a time slot method or a modulation of carrier frequencies.

The application of techniques, such as those described above in connection with the communication interface, make it possible to use a single cable to contact the sensor arrangement. This simplifies the use and reduces the risk that an incorrect contact is established by the user.

A system comprises a sensor arrangement as described above. In addition, the system comprises an RF front end which is electrically coupled to the one or more conductor structures. The RF front end is configured to perform radar measurements based on electromagnetic waves. Furthermore, the system comprises a sensor driver circuit which is electrically coupled to the at least one sensor. The sensor driver circuit is configured to perform a measurement of the at least one measured variable. Finally, the system also includes a processor. The processor is configured to determine an intended speech utterance of the person based on the radar measurement and based on the measurement of the at least one measured variable.

The RF front end and the sensor driver circuit can be connected to the sensor arrangement via a common cable. The corresponding signals can be transmitted via the common cable by using the communication interface as described above.

A method comprises the characterization of a person's vocal tract using a radar measurement and a measurement of at least one measured variable. A sensor arrangement as described above is used. Then, based on the characterization of the vocal tract, an intended speech utterance of the person can be determined.

The features and characteristics set forth above and those described below can be used not only in the corresponding combinations explicitly described but also in other combinations or in isolation without departing from the scope of protection of the present invention.

### BRIEF DESCRIPTION OF THE DRAWINGS

FIG. 1 is a schematic lateral view of an exemplary sensor arrangement.

FIG. 2 is a schematic view of a system according to different examples.

### DETAILED DESCRIPTION

The characteristics, features and advantages of the present invention described above, as well as the way in which they are achieved, will become clearer and more precisely understandable by means of the following description of the exemplary embodiments which will be explained in more detail in connection with the drawings.

In the following, the present invention will be discussed in more detail by means of preferred embodiments with reference to the figures. The same reference numerals in the figures denote the same or similar elements. The figures are schematic representations of various embodiments of the invention. The elements depicted in the figures are not necessarily shown to scale. Rather, the various elements illustrated in the figures are represented in such a way that their function and general purpose are understandable to those skilled in the art. Connections and couplings between functional entities and elements illustrated in the figures can also be implemented as indirect connections or couplings. A connection or coupling may be implemented in a wire-based or wireless fashion. Functional entities may be implemented as a hardware or software solution, or as a combined solution of hardware and software.

The following description discloses techniques that allow to perform radar measurements in near-body applications. For example, medical applications could be made possible. Examples relate to applications such as the determination of intended speech utterances when a person has no or limited phonation abilities.

A multi-modal sensor arrangement is disclosed, which combines an antenna for the radar measurement with one or more further sensors that measure one or more measured variables. In this way, the vocal tract of a person can be characterized. For example, silent speech recognition can be realized.

A multi-modal sensor arrangement is disclosed, which combines an antenna for the radar measurement with one or more further sensors that measure one or more measured variables. In this way, the vocal tract of a person can be characterized. For example, silent speech recognition can be realized.

For example, the one or more further sensors could be used to check whether the antenna is correctly positioned relative to the skin surface.

It would be possible to determine an intended speech utterance of a person. It is conceivable to determine a text that describes a textual reproduction of the speech corresponding to the intended speech utterance. An audio output (i.e., an audio signal), which corresponds to the speech utterance, could be determined. In the following, the term ‘determination of a synthetic language of a person’ is used for all such variants.

The synthetic speech can also be determined, in particular, if the person is physically not able to produce sounds. This means that “silent speech” is made possible. It is known that three to nine percent of the population in industrialized countries are affected by voice disorders. They express themselves in a range of symptoms that are summarized under the term dysphonia: from hoarseness to weak or distorted speech to a complete loss of voice, which is referred to as aphonia. Voice disorders can be of functional or organic origin. Organic voice disorders can be further subdivided into structural or neurogenic disorders. “Silent speech” can be made possible for persons with such voice disorders.

Synthetic speech can also be generated, if the person intentionally whispers or silently articulates. This could, for example, enable a private “conversation” over the phone.

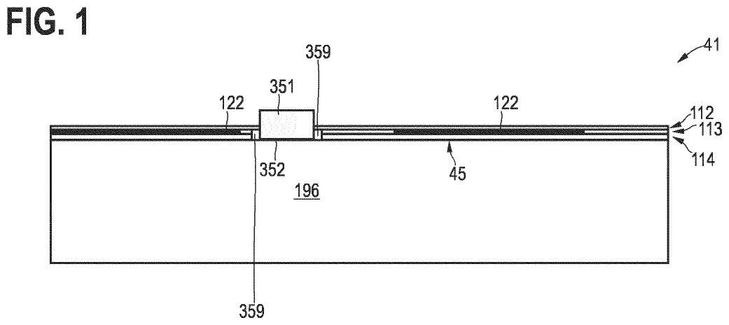

FIG. 1 is a schematic lateral view of an exemplary sensor arrangement 41. The sensor arrangement 41 is applied with its underside 45 to a skin surface 196 of the person. The sensor arrangement 41 has a carrier structure 112, here implemented as a carrier layer or carrier film. The carrier structure can be designed to be elastic in order to adapt to different surface shapes of the skin surface 196.

A metal layer 113 is applied to the carrier structure 112; this layer could be implemented, for example, as a film-based circuit. The metal layer 113 comprises several metallic conductor structures 122 (shown in FIG. 1 in black contrast). These conductor structures 122 are configured to emit or detect electromagnetic waves. For this purpose, RF currents can be fed into the conductor structures 122 or detected.

An adhesive film 114 is provided underneath the conductor structures 122; however, this is optional. By using the adhesive film 114, the sensor arrangement 41 can be fixed to the skin surface without an air gap.

In addition, a sensor 351 is provided. The sensor is attached with a sensitive area 352 directly onto the skin surface 196. This is made possible by a corresponding recess 359 that extends through the layers 112-114. The sensor 351 is partially arranged in the recess 359. Generally, the recess would not have to penetrate all layers 112, 113, 114; it is conceivable, for example, that only the adhesive film 114 will have a recess, if the sensor 351 is implemented in a particularly flat manner (such as a MEMS acceleration sensor).

The sensor 351 could, for example, measure a stretching of the skin surface 196.

Another possibility would be that the sensor 351 measures the acceleration. In such a case, the sensor would not have to rest directly on the skin surface 196.

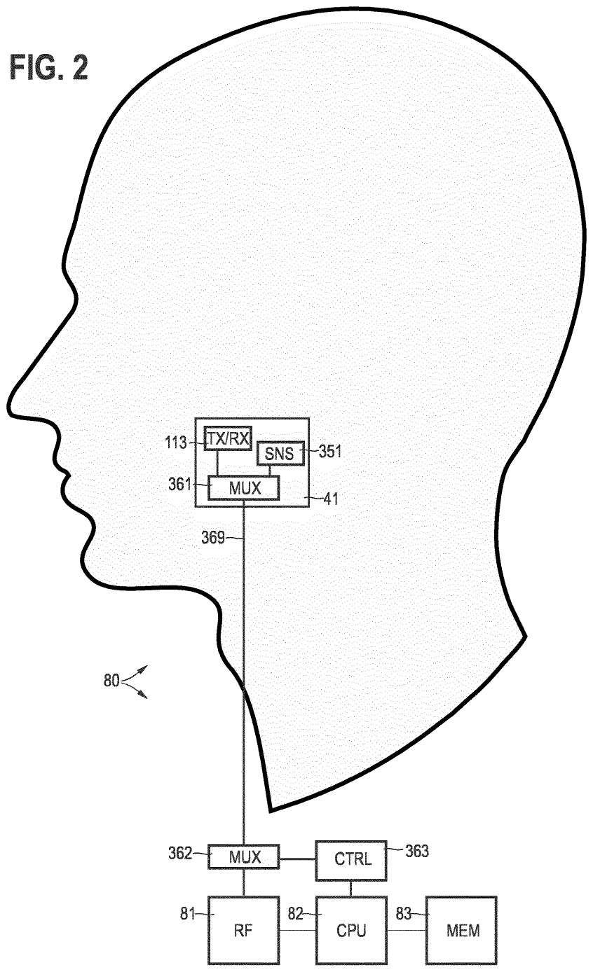

FIG. 2 shows aspects in connection with an exemplary system 80. The system 80 comprises the sensor arrangement 41, which—as described in connection with FIG. 1—includes the conductor structures 122 and the sensor 351.

Furthermore, a communication interface 361 is provided, which is connected to a corresponding communication interface 362 via a cable 369. The communication interface 361 can be configured, for example, to multiplex or demultiplex signals from or for the conductor structures 122 with signals from or for the sensor 351. In a simple variant, the communication interface 361 could feed the signals of both types into the cable 369 in a superimposed manner. Active multiplex techniques could also be used, in the frequency domain or in the time domain. The corresponding communication interface 362 can also be configured according to the implementation of the communication interface 361.

In principle, it is also conceivable, for example, that the radar signals are transmitted in a wired manner via the cable 369, but signals from or for the sensor 351 are transmitted wirelessly. For example, radar signals could be transmitted together with a DC supply voltage for the sensor 351 via the cable 369, whereas measurement data from the sensor 351 is transmitted wirelessly.

FIG. 2 also shows an RF front end 81. It is configured to feed RF currents into the conductor structures 122 via the cable 369 and/or to detect RF currents induced by electromagnetic waves in the conductor structures 122 and to convert them into digital signals. The RF front end 81 can, for example, comprise a frequency mixer, an oscillator, an RF amplifier and a filter.

Furthermore, a sensor driver circuit 363 is shown. It is configured to implement a measurement of a measured variable by means of the sensor 351. The sensor driver circuit can supply the sensor 351 with an operating voltage. The sensor driver circuit could read out the sensor 351.

The system 80 also comprises a processor 82. The processor 82 is configured to determine an intended speech utterance of the person based on the radar measurement by means of the conductor structures 122 and based on the measurement of the measured variable by means of the sensor 351, for example, based on a program code that is loaded from the memory 83 and executed.

In FIG. 1 and FIG. 2, the sensor arrangement 41 comprises only a single sensor 351. In principle, it is conceivable that the sensor arrangement 41 comprises several sensors (in addition to the antenna for the radar measurement). These several sensors can measure different measured variables, for example acceleration and tension/strain.

Principally, the radar measurement can be carried out in reflections; in this case, one and the same conductor structure 122 can be used to emit and to detect the electromagnetic waves. In some examples, however, a radar measurement in transmission would also be conceivable. In this case, a further antenna can be provided to emit the electromagnetic waves that are subsequently detected by the conductor structures 122; or a further antenna can be provided to detect the emitted electromagnetic waves.

Of course, the features of the embodiments and aspects of the present invention described above can be combined with one another. In particular, the features can be used not only in the combinations described but also in other combinations or on their own without departing from the field of this invention.

1. A sensor arrangement for near-body application, the sensor arrangement comprising:
a carrier structure,
one or more conductor structures which are attached to the carrier structure and which are configured to emit or detect electromagnetic waves of a radar measurement, and
at least one sensor which is attached to the carrier structure and which is designed to detect at least one measured variable.

2. The sensor arrangement according to claim 1,
wherein the at least one measured variable comprises a strain.

3. The sensor arrangement according to claim 1,
wherein the at least one measurement variable comprises an acceleration.

4. The sensor arrangement according to claim 1,
wherein the at least one measurement variable comprises a conductivity.

5. The sensor arrangement according to claim 1, further comprising:
an adhesive layer which extends along the carrier structure and which includes a recess,
wherein the at least one sensor is arranged at least partially within the recess.

6. The sensor arrangement according to claim 1, further comprising:
a communication interface configured to multiplex and/or demultiplex first signals, associated with the one or more conductor structures, and second signals, associated with the at least one sensor, for transmission via a cable.

7. A system comprising:
the sensor arrangement according to claim 1,
an RF front end which is coupled to the one or more conductor structures and which is configured to perform a radar measurement based on electromagnetic waves,
a sensor driver circuit which is coupled to the at least one sensor and configured to perform a measurement of the at least one measured variable, and
a processor which is configured to determine an intended speech utterance based on the radar measurement and based on the measurement of the at least one measured variable.

8. A method, comprising:
characterizing a vocal tract of a person by means of a radar measurement and a further measurement of at least one measured variable using the sensor arrangement according to claim 1, and
determining an intended speech utterance of the person based on the characterization of the vocal tract.

9. A method, comprising:
checking a contact of the sensor arrangement according to claim 1 with a skin surface based on a measurement of the at least one measured variable.
